(19) United States
(12) Patent Application Publication
(10) Pub. No.: US 2017/0355546 A1
(43) Pub. Date: Dec. 14, 2017

(54) SHEET CONVEYANCE DEVICE AND IMAGE FORMING APPARATUS

(71) Applicant: CANON KABUSHIKI KAISHA, Tokyo (JP)

(72) Inventor: Takuma Koizumi, Toride-shi (JP)

(21) Appl. No.: 15/603,674

(22) Filed: May 24, 2017

(30) Foreign Application Priority Data
Jun. 8, 2016 (JP) 2016-114407

(51) Int. Cl. B65H 9/00; G03G 15/00

(52) U.S. Cl. CPC B65H 9/006; G03G 15/6567; B65H 2801/06; B65H 2404/13161

(57) ABSTRACT

A sheet conveyance device includes a registration roller pair including a first roller and a second roller, configured to form a nip by the first roller and the second roller, and configured to correct a skew of a sheet conveyed thereto by allowing the sheet to abut the nip. The first roller includes an outer peripheral surface with a groove portion, the groove portion being formed in a region in which a corner portion of a sheet abuts the outer peripheral surface, and causing a part of the outer peripheral surface to be concave and another part of the outer peripheral surface to be convex in an axial direction.

### BACKGROUND OF THE INVENTION

### Field of the Invention

The present invention relates to a sheet conveyance device configured to convey a sheet, and to an image forming apparatus.

### Description of the Related Art

Some printers, copiers, facsimile machines, and automatic document feeders: ADFs include a registration roller pair that corrects the skew of a sheet conveyed thereto. In the case of correcting the skew of a sheet by using the registration roller pair, a pre-registration roller pair disposed upstream of the registration roller pair in a sheet conveyance direction causes the sheet to form a loop by causing the sheet to abut a nip of the registration roller pair whose rotation is stopped. A force generated by the loop rotates the sheet such that a leading end of the sheet is aligned with the registration roller pair, and thus the skew is corrected. Then, the sheet whose skew has been corrected is conveyed by rotating the registration roller pair.

The registration roller pair is constituted by a registration driving roller driven by a motor and a registration driven roller that rotates along with the registration driving roller, and the registration driving roller is configured such that a driving force is transmitted from the motor via a gear system such as a gear train. Therefore, there is a risk that, when the sheet abuts the registration roller pair, the skew is not sufficiently corrected as a result of the registration roller pair being slightly rotated due to a backlash of the gear system and thus the leading end of the sheet being nipped by the registration roller pair and the rotation of the sheet being hindered. In consideration of this risk, Japanese Patent Laid-Open No. 2012-30931 proposes a configuration in which the registration driving roller is stopped after being driven against the direction in which the sheet is conveyed. That is, the configuration disclosed in Japanese Patent Laid-Open No. 2012-30931 is made so as to prevent the rotation of the registration roller pair caused by the backlash when the sheet abuts the registration roller pair such that the skew correction does not become insufficient.

In recent years, improvement in productivity in successive printing, successive reading, and the like, that is, acceleration of the speed in these operations is desired. In order to improve the productivity, it is required to shorten the intervals between sheets conveyed successively. However, in the case where the intervals are shortened in such a system as disclosed in Japanese Patent Laid-Open No. 2012-30931 described above in which the registration driving roller is rotated in a reverse rotation direction before the sheet abuts the registration roller pair, sufficient time for reverse rotation is not ensured in the shortened intervals, and thus the rotation caused by the backlash is not sufficiently prevented. Therefore, a problem that the skew correction of the sheet becomes insufficient arises.

### SUMMARY OF THE INVENTION

According to a first aspect of the present invention, a sheet conveyance device includes a registration roller pair including a first roller and a second roller, configured to form a nip by the first roller and the second roller, and configured to correct a skew of a sheet conveyed thereto by allowing the sheet to abut the nip. The first roller includes an outer peripheral surface with a groove portion, the groove portion being formed in a region in which a corner portion of a sheet abuts the outer peripheral surface, and causing a part of the outer peripheral surface to be concave and another part of the outer peripheral surface to be convex in an axial direction.

According to a second aspect of the present invention, a sheet conveyance device including a registration roller pair including a first roller and a second roller, configured to form a nip by the first roller and the second roller, and configured to correct a skew of a sheet conveyed thereto by allowing the sheet to abut the nip. The first roller comprises plural grooves arranged in an axial direction.

Further features of the present invention will become apparent from the following description of exemplary embodiments with reference to the attached drawings.

### BRIEF DESCRIPTION OF THE DRAWINGS

FIG. 1 is a section view of an image forming apparatus according to an exemplary embodiment illustrating a configuration thereof.

FIG. 2 is a perspective view of a registration roller pair according to the exemplary embodiment.

FIG. 3 is a section view of the registration roller pair according to the exemplary embodiment illustrating the shape thereof.

FIG. 4 is a schematic diagram illustrating a state in which a sheet is nipped by the registration roller pair according to the exemplary embodiment.

FIG. 5 is a schematic diagram illustrating a state in which a sheet is nipped by a registration roller pair having smooth outer peripheral surfaces.

### DESCRIPTION OF THE EMBODIMENTS

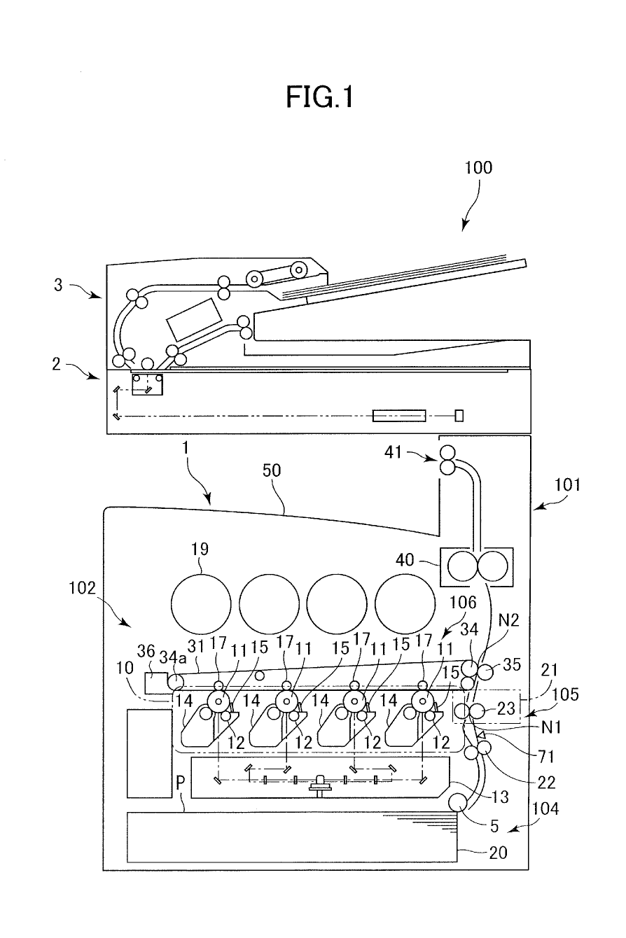

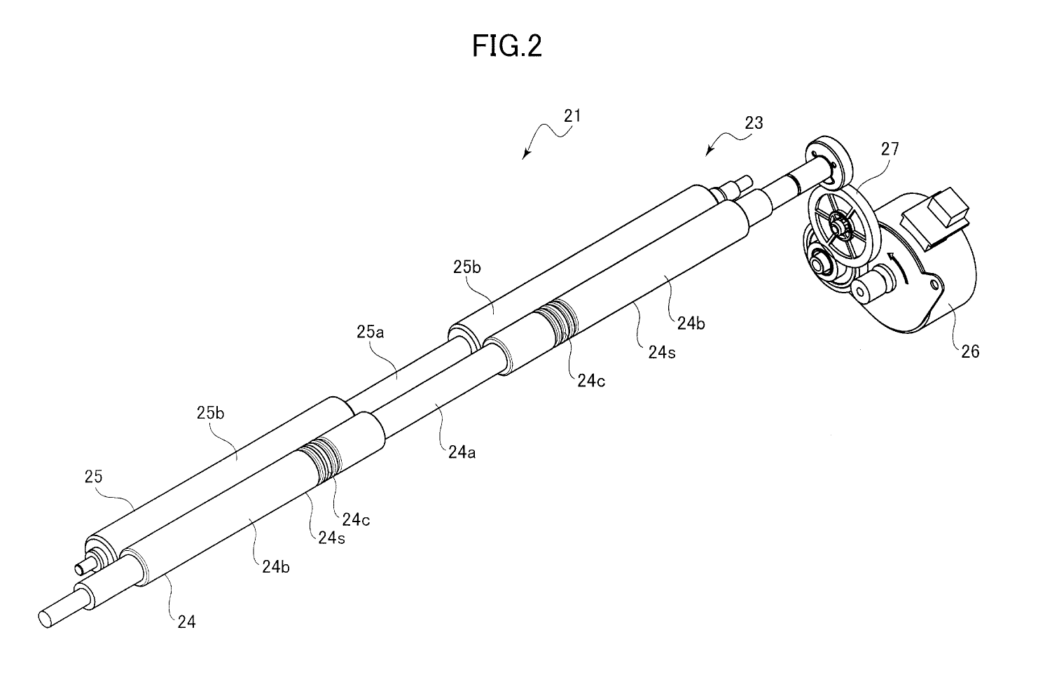

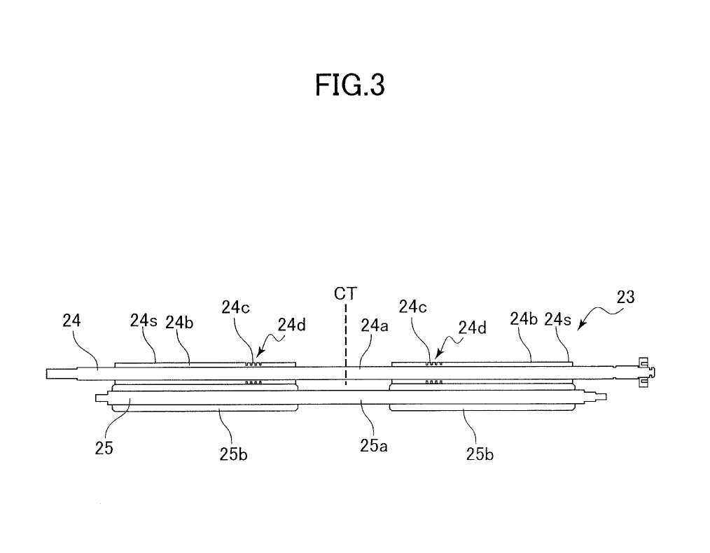

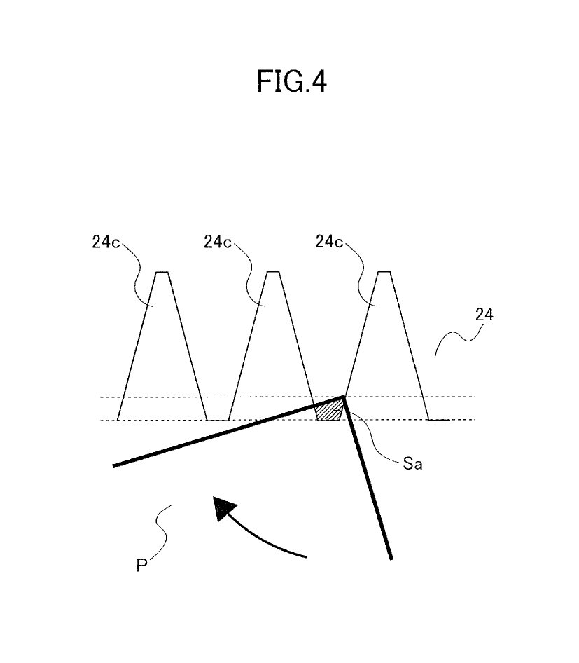

An exemplary embodiment will be described below with reference to FIGS. 1 to 4. FIG. 1 is a section view of an image forming apparatus according to the present exemplary embodiment illustrating a configuration thereof. FIG. 2 is a perspective view of a registration roller pair according to the present exemplary embodiment. FIG. 3 is a section view of the registration roller pair according to the present exemplary embodiment illustrating the shape thereof. FIG. 4 is a schematic diagram illustrating a state in which a sheet is nipped by the registration roller pair according to the present exemplary embodiment.

### Configuration of Image Forming Apparatus

As illustrated in FIG. 1, a printer 100 includes a printer body 101 including an image forming portion 102, a sheet conveyance device 105, and so forth. An image reading device 2 that reads a document automatically conveyed by an automatic document conveyance device 3 is provided above the printer body 101. In addition, a sheet feeding device 104 is provided in a lower portion of the printer body 101. A sheet fed by the sheet feeding device 104 is conveyed to the image forming portion 102 by the sheet conveyance device 105, subjected to image formation at the image forming portion 102, and then conveyed to a sheet discharge roller pair 41. Then, the sheet on which an image has been formed is discharged onto a sheet discharge tray 50 by the sheet discharge roller pair 41.

The image forming portion 102 is of a four-drum full-color type, and includes a laser scanner 13 and four process cartridges 10 that respectively form toner images of four colors of yellow, magenta, cyan, and black. Correspondence to yellow, magenta, cyan, and black will be hereinafter respectively indicated by letters Y, M, C, and K. The process cartridges 10 each include a photosensitive drum 11, a charging roller 12, a developing unit 14, and a cleaner 15. The charging roller 12 serving as a charging portion, and the developing unit 14 serving as a developing portion. In addition, the image forming portion 102 includes toner cartridges 19 and an intermediate transfer unit 106. The intermediate transfer unit 106 is disposed above the process cartridges 10.

The intermediate transfer unit 106 includes an intermediate transfer belt 31 that rotates in a state of being looped over a secondary transfer inner roller 34, a tension roller 34a, and so forth. In addition, the intermediate transfer unit 106 includes primary transfer rollers 17 that are disposed on the inner peripheral surface side of the intermediate transfer belt 31 and are in contact with the intermediate transfer belt 31 at positions opposing respective photosensitive drums 11.

By applying a transfer bias of a positive polarity to the intermediate transfer belt 31 via the primary transfer rollers 17, toner images of respective colors having a negative polarity on the photosensitive drums 11 are sequentially transferred onto the intermediate transfer belt 31 so as to be superimposed on one another. In addition, a secondary transfer outer roller 35 is disposed at a position opposing the secondary transfer inner roller 34 in the intermediate transfer unit 106. The secondary transfer outer roller 35 constitutes a secondary transfer portion at which a color image formed on the intermediate transfer belt 31 is transferred onto a sheet.

The sheet feeding device 104 includes a feed cassette 20 and a feed roller 5. Sheets P accommodated in the feed cassette 20 are fed one by one from the feed cassette 20 by the feed roller 5 by being separated from one another by a separation portion that is not illustrated. The sheet conveyance device 105 includes a pre-registration roller pair 22, registration roller pair 23 of a registration unit 21, and so forth. The pre-registration roller pair 22 serves as an example of a conveyance roller pair. A sheet P separated and conveyed by the sheet feeding device 104 is nipped and conveyed by the pre-registration roller pair 22 disposed upstream of the registration roller pair 23. Then, the skew of the sheet P nipped and conveyed by the pre-registration roller pair 22 is corrected by the registration roller pair 23, which is disposed downstream of the pre-registration roller pair 22 in a sheet conveyance direction, and the sheet P is further conveyed by the registration roller pair 23. That is, a corner portion of a leading end of the sheet P nipped and conveyed by the pre-registration roller pair 22 is caused to abut a nip N1 of the registration roller pair 23 of the registration unit 21 whose rotation is stopped. Then, the skew of the sheet P nipped and conveyed by the pre-registration roller pair 22 is corrected by causing the leading end of the sheet P to align with the nip N1 and the sheet P to form a loop. Afterwards, the registration roller pair 23 is driven to rotate, and the sheet P whose skew has been corrected is nipped and conveyed by the registration roller pair 23.

Then, the registration roller pair 23 conveys the sheet P to a position between the intermediate transfer belt 31 and the secondary transfer outer roller 35 in a manner synchronized with conveyance of the toner image on the outer peripheral surface of the intermediate transfer belt 31. The color toner image on the outer peripheral surface of the intermediate transfer belt 31 is subjected to a predetermined pressurizing force and electrostatic load bias voltage at a nip N2 between the secondary transfer outer roller 35 and the secondary transfer inner roller 34 disposed on the inner peripheral surface side of the intermediate transfer belt 31 so as to oppose the secondary transfer outer roller 35. According to this, the toner image on the outer peripheral surface of the intermediate transfer belt 31 is transferred onto the sheet P. Toner remaining on the intermediate transfer belt 31 after the transfer is removed and collected by a transfer cleaner 36 for preparation for next image formation.

The sheet P onto which the toner image has been transferred is conveyed to a fixing portion 40, and, when the sheet P passes through the fixing portion 40, the transferred toner image is heated and pressurized and is thus fixed onto the sheet P. Then, the sheet P onto which the toner image has been fixed is discharged by the sheet discharge roller pair 41 onto the sheet discharge tray 50, which is an upper surface of the printer body 101.

### Configuration of Registration Unit

The configuration of the registration unit 21 will be described next. As illustrated in FIG. 2, the registration unit 21 includes the registration roller pair 23, a motor 26, and a gear train 27. The motor 26 serves as an example of a rotational drive source. The registration roller pair 23 includes a registration driving roller 24 and a registration driven roller 25 rotationally disposed parallel to the registration driving roller 24. Rotational drive is transmitted to the registration driving roller 24 via the gear train 27 configured to transmit the rotational drive output from the motor 26. The registration driven roller 25 is disposed so as to oppose the registration driving roller 24, is urged toward the registration driving roller 24 by an urging member that is not illustrated, and rotates along with the rotation of the registration driving roller 24. The registration driving roller 24 includes a metal shaft 24a and two rubber rollers 24b. The rubber rollers 24b are disposed at positions symmetrical in an axial direction, i.e., a shaft direction, with respect to a conveyance center line CT illustrated in FIG. 3 and are fixed to the metal shaft 24a so as to be relatively unrotatable with respect to the metal shaft 24a. The metal shaft 24a serves as an example of a first rotation shaft, and the rubber rollers 24b serve as an example of plural first rollers. In addition, the registration driven roller 25 includes a metal shaft 25a and two plastic rollers 25b. The plastic rollers 25b are disposed at positions symmetrical in the axial direction with respect to the conveyance center line CT illustrated in FIG. 3 and are fixed to the metal shaft 25a so as to be relatively unrotatable with respect to the metal shaft 25a. The metal shaft 25a serves as an example of a second rotation shaft, and the plastic rollers 25b serve as an example of plural second rollers. That is, the rubber rollers 24b and the plastic rollers 25b are disposed at such positions that the rubber rollers 24b oppose and are in contact with the plastic rollers 25b, and the nip N2 illustrated in FIG. 1 is formed by these rollers. That is, the rubber rollers 24b included in the registration driving roller 24 and the plastic rollers 25b included in the registration driven roller 25 constitute, by forming the nip N2, plural sheet contact portions that come into contact with and convey a sheet whose skew has been corrected. Moreover, in the present exemplary embodiment, plural groove portions 24c are defined in parts of outer peripheral surfaces 24s of the rubber rollers 24b of the registration driving roller 24.

As illustrated in FIG. 3, the groove portions 24c are arrayed in the axial direction such that the groove direction thereof is parallel to a plane perpendicular to the axial direction, that is, the groove direction is parallel to the conveyance center line CT of a sheet. The groove portions 24c form a shape including recesses and projections in the axial direction, in other words, in a thrust direction, on the outer peripheral surfaces 24s of the registration driving roller 24. That is, the first roller 24 comprises an outer peripheral surface 24s with a groove portion 24c, the groove portion 24c being formed in a region in which a corner portion of a sheet abuts the outer peripheral surface, and causing a part of the outer peripheral surface to be concave and another part of the outer peripheral surface to be convex in an axial direction. In the present exemplary embodiment, plural grooves continuous in the circumferential direction are arranged in the axial direction. However, the shape including recesses and projections in the axial direction may be formed by one continuous spiral groove. Intervals between the groove portions 24c, that is, the pitch of the shape including recesses and projections in the axial direction, which is the distance between centers of adjacent recesses in the present exemplary embodiment, are preferably 0.5 mm or larger and 5 mm or smaller. In the present exemplary embodiment, the pitch is set to 3 mm. Widths of the projections in the outer peripheral surfaces 24s constituting the shape including recesses and projections are preferably 0.2 mm or larger and 4 mm or smaller. In the present exemplary embodiment, the width of each projection is set to 1 mm.

Plural projection portions are formed in the parts of the outer peripheral surfaces 24s of the registration driving roller 24 in which the plural groove portions 24c are formed. The parts including the groove portions 24c of the registration driving roller 24 are constituted by the rubber rollers 24b, and parts of the registration driving roller opposing the parts including the groove portions 24c are constituted by the plastic rollers 25b. That is, since the rubber rollers 24b have a smaller rigidity than the plastic rollers 25b, the sheet nipped and conveyed by the registration roller pair 23 is not damaged.

The plural groove portions 24c, that is, the shape including recesses and projections in the outer peripheral surfaces 24s, are defined in two regions 24d provided at positions to be in contact with corner portions of the leading end of a sheet in the axial direction of the registration driving roller 24. The two regions 24d serve as an example of plural regions. That is, since the direction in which the sheet conveyed to the registration roller pair 23 is inclined with respect to the conveyance direction is not constant, either one of the two corner portions of the leading end of the sheet abuts the registration driving roller 24 earlier than the other. Therefore, the regions 24d in which the plural groove portions 24c are provided are disposed so as to be symmetrical with each other with respect to the sheet conveyance center line CT, that is, the center in the axial direction, of the registration driving roller 24. In other words, the region in which a corner portion of a sheet abuts the outer peripheral surface includes first and second regions disposed at positions symmetrical in the axial direction with respect to the conveyance center line of the sheet conveyed to the registration roller pair and the first and second regions are provided with first and second groove portions, respectively. It is noted that the first region is located on the first contact portion and the second region is located on the second contact portion which is formed separately from the first contact portion.

In addition, even in the case where the dimension, or, the size, of the sheet conveyed to the registration roller pair 23 is the same in the axial direction, the position in the axial direction at which the sheet abuts the registration roller pair 23 may vary. Therefore, the plural groove portions 24c are defined in positions determined in consideration of a margin of error such that the positions at which corner portions of the leading end of the sheet abuts are in the regions 24d, in which the plural groove portions 24c are defined, even in the case where the position of the conveyed sheet varies in the axial direction. The sheet whose skew has been corrected is nipped by the plastic rollers 25b and parts of the outer peripheral surfaces 24s of the rubber rollers 24b of the registration driving roller 24 in which the plural groove portions 24c are not provided.

Sheets of various dimensions, that is, sheets of plural different sizes, can be used in the printer 100, and thus the dimensions of sheets conveyed to the registration roller pair 23 are not uniform in the axial direction. However, how easily the skew of a sheet can be corrected varies depending on the dimension of the sheet. A sheet of a smaller dimension in the axial direction generates a smaller rotational force, and thus it is more difficult to correct the skew of a sheet of a smaller dimension. Therefore, the regions 24d corresponding to positions in the axial direction at which the plural groove portions 24c are defined are set at such positions that at least corner portions of the leading end of a sheet of the smallest dimension in the axial direction among plural types of sheets having different dimensions that are preset to be conveyable in the printer 100 abut the regions 24d. In this way, both of nip-conveyance performance for sheets of large sizes and skew-correction performance for sheets of small sizes can be achieved at the same time. As a matter of course, regions of the plural groove portions 24c may be set for dimensions of all types of sheets in correspondence with positions at which corner portions of leading ends of the sheets abut as long as a sufficient nip-conveyance performance for the sheets is secured.

### Operation in Skew Correction

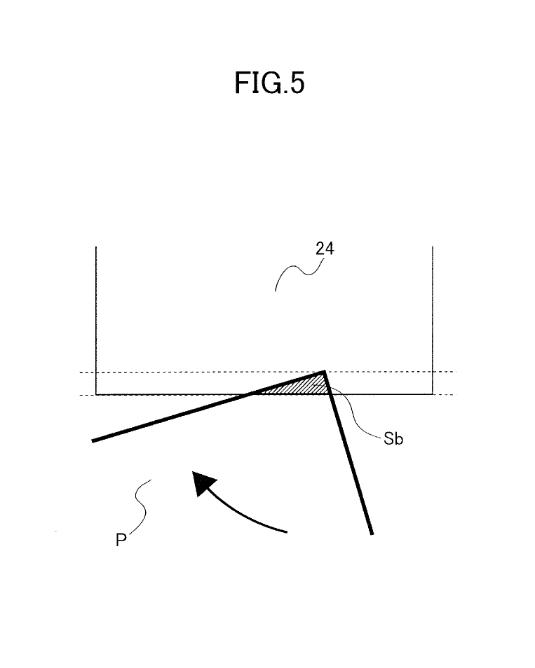

Next, an operation in skew correction by the registration roller pair 23 in the present exemplary embodiment will be described with reference to FIG. 4. FIG. 5 is a schematic diagram illustrating a state in which a sheet is nipped by a registration roller pair having smooth outer peripheral surfaces. In other words, FIG. 5 is a schematic diagram illustrating a case where groove portions are not formed on the registration driving roller 24 of the registration roller pair 23 as a comparative embodiment.

In the printer 100 according to the present exemplary embodiment, in the case of successively conveying sheets, intervals between the sheets are set to be small so as to improve the productivity in successive printing, and there is not enough time to rotate the registration roller pair 23 in a reverse rotation direction. Accordingly, in the printer 100, control for rotating the registration roller pair 23 in the reverse rotation direction is not performed. Therefore, when a corner portion of the leading end of the sheet P abuts the registration roller pair 23, the registration roller pair 23 rotates by an amount corresponding to the backlash of the gear train 27 and slightly pinches the corner portion of the leading end of the sheet P.

In the case where the groove portions 24c are not defined on the registration driving roller 24 as in the comparative embodiment illustrated in FIG. 5, a corner portion of the leading end of the sheet P is nipped by the registration roller pair 23 that has rotated by the amount corresponding to the backlash, and the area of a nipped portion of the sheet P is “area Sb”. In contrast, in the case where the plural groove portions 24c are defined on the registration driving roller 24 as in the present exemplary embodiment illustrated in FIG. 4, portions of the sheet P corresponding to the groove portions 24c are not nipped even though the registration roller pair 23 is rotated by the amount corresponding to the backlash. Therefore, only the projections contribute to nipping of the sheet P in the regions 24d, and thus the area of the portion of the sheet P nipped by the outer peripheral surfaces 24s of the registration driving roller 24 is “area Sa”, which is smaller than the area Sb described above. That is, Sb>Sa holds. As a matter of course, if the amount of the backlash of the gear train 27 is the same, the amount of rotation of the registration driving roller 24 rotated due to abutting of the sheet P is also the same.

In this way, in the case where the area of the portion of the corner portion of the leading end of the sheet P nipped by the registration roller pair 23 is smaller, the portion is more likely to behave as a point, and thus the sheet P can be rotated in the direction of an arrow illustrated in FIG. 4 more easily about the corner portion of the leading end of the sheet P nipped by the registration roller pair 23. Therefore, when the sheet P forms a loop by being kept conveyed by the pre-registration roller pair 22, the sheet P is more likely to rotate, that is, the skew of the sheet P can be more easily corrected.

In addition, as described above, the rubber rollers 24b are fixed to the metal shaft 24a of the registration driving roller 24, and the plastic rollers 25b are fixed to the metal shaft 25a of the registration driven roller 25. Although the rubber rollers 24b have a larger frictional resistance than the plastic rollers 25b, the rubber rollers 24b have a smaller contact area with the sheet P than the plastic roller 25b due to the plural groove portions 24c. Therefore, the frictional force applied to the corner portion of the leading end of the sheet P nipped by the registration roller pair 23 by the rubber rollers 24b is reduced due to the smaller contact area, and thus the sheet P is more likely to rotate and the skew of the sheet P can be more easily corrected.

To be noted, as described above, the rubber rollers 24b have a smaller rigidity than the plastic rollers 25b. Thus, in the case where, for example, groove portions are defined on the plastic rollers 25b, there is a risk that the sheet P is damaged when the sheet P is rotated. However, in the present exemplary embodiment, since the groove portions 24c are provided on the rubber rollers 24b, which have a smaller rigidity, the sheet P is not damaged when the sheet P is rotated.

Summary of Present Exemplary Embodiment

As described above, according to the printer 100 of the present exemplary embodiment, the registration roller pair 23 is slightly rotated by, for example, the backlash of the gear train 27, and a corner portion of the leading end of a sheet is nipped by the registration roller pair 23. In this case, since the plural groove portions 24c are defined on the registration driving roller 24, the area of the portion of the leading end of the sheet nipped by the registration roller pair 23 can be reduced. Therefore, the sheet can be more easily rotated about the nipped portion of the leading end of the sheet. Accordingly, it can be attempted to prevent the occurrence of insufficient skew correction even in the case where the intervals of sheets successively conveyed is reduced in order to improve the productivity.

In addition, the plural groove portions 24c are defined in the regions 24d at which corner portions of the leading end of a sheet abut the registration driving roller 24. Therefore, the sheet can be more easily rotated about a corner portion of the leading end of the sheet nipped by the registration roller pair 23.

In addition, the regions 24d in which the plural groove portions 24c correspond to regions in which corner portions of a sheet of the minimum size in the width direction, among sheets of sizes preset to be conveyable in the printer 100, abut the registration roller pair 23. According to this, it becomes possible to, for example, achieve both of nip-conveyance performance for sheets of larger than the minimum size and skew-correction performance for the sheet of the minimum size at the same time.

Further, the regions 24d in which the plural groove portions 24c are defined are plural regions disposed at positions symmetrical in the axial direction with respect to the conveyance center line of a conveyed sheet. According to this, skew correction of a sheet can be performed sufficiently even in the case where the direction in which the sheet is inclined with respect to the conveyance direction is not constant.

In addition, the plural groove portions 24c are defined not on the plastic rollers 25b but on the rubber rollers 24b. Thus, the frictional force is reduced and the sheet is more likely to rotate. Further, it can be attempted to prevent a damage to the sheet.

### OTHER EMBODIMENTS

Although a configuration in which the groove portions 24c are provided on the registration driving roller 24 of the registration roller pair 23 has been described in the present exemplary embodiment, groove portions may be provided on the registration driven roller 25. Further, groove portions may be provided on both of the registration driving roller 24 and the registration driven roller 25. In addition, in the case of providing groove portions on the registration driven roller 25, the registration driven roller 25 may be constituted by a rubber roller. In this case, the registration driving roller 24 may be constituted by a plastic roller. In addition, groove portions may be provided on the plastic roller, and, in this case, corners of projections formed between groove portions may be rounded such that the sheet is not damaged by the projections.

In addition, although a configuration in which the registration roller pair 23 is not caused to rotate in the reverse rotation direction before the sheet comes into contact therewith has been described in the present exemplary embodiment, the registration roller pair 23 may be caused to rotate in the reverse rotation direction for a possible period of time in order to reduce the area of the nipped portion of the sheet even if the reverse rotation does not fully cancel the backlash.

In addition, a configuration in which the groove portions 24c are defined in correspondence with a sheet of the minimum size among sheets of sizes preset to be conveyable in the printer 100 has been described in the present exemplary embodiment. However, the configuration is not limited to this, and the regions in which the groove portions 24c are defined may be set in the axial direction in correspondence with a sheet of the second smallest size, a sheet of the third smallest size, or the like. That is, the regions in which groove portions are defined may be set such that nip-conveyance performance for sheets of large sizes and skew-correction performance for sheets of small sizes can be achieved at the same time.

In addition, although a configuration in which the registration roller pair 23 is included in the sheet conveyance device 105 in the printer body 101 has been described in the present exemplary embodiment, groove portions may be defined on a registration roller pair of a sheet conveyance device in the automatic document conveyance device 3. In this case, it can be attempted to achieve a high speed and a high skew correction performance in successive reading of documents serving as an example of sheets.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2016-114407, filed Jun. 8, 2016, which is hereby incorporated by reference wherein in its entirety.

What is claimed is:

1. A sheet conveyance device comprising:
a registration roller pair comprising a first roller and a second roller, configured to form a nip by the first roller and the second roller, and configured to correct a skew of a sheet conveyed thereto by allowing the sheet to abut the nip,
wherein the first roller comprises an outer peripheral surface with a groove portion, the groove portion being formed in a region in which a corner portion of a sheet abuts the outer peripheral surface, and causing a part of the outer peripheral surface to be concave and another part of the outer peripheral surface to be convex in an axial direction.

2. The sheet conveyance device according to claim 1, wherein the region is a region in which a corner portion of a sheet of a minimum size in a width direction among sheets of sizes preset to be conveyable abuts the outer peripheral surface.

3. The sheet conveyance device according to claim 1, wherein the region comprises first and second regions disposed at positions symmetrical in the axial direction with respect to a conveyance center line of the sheet conveyed to the registration roller pair, and
the groove portion is a first groove portion formed in the first region and the first roller comprises a second groove portion formed in the second region.

4. The sheet conveyance device according to claim 3, wherein the first roller comprises first and second sheet contact portions formed separately from each other and configured to convey a sheet, and
the first region is located on the first contact portion and the second region is located on the second contact portion.

5. The sheet conveyance device according to claim 1, wherein the groove portion is one of a plurality of groove portions arrayed in the axial direction, and the plurality of the groove portions causes the outer peripheral surface to have recesses and projections in the axial direction.

6. The sheet conveyance device according to claim 5, wherein the plurality of the groove portions is defined in a direction parallel to a conveyance center line of a sheet.

7. The sheet conveyance device according to claim 1, wherein the groove portion is a spiral groove portion which causes the outer peripheral surface to have recesses and projections in the axial direction.

8. The sheet conveyance device according to claim 1, wherein the first roller has a smaller rigidity than the second roller.

9. The sheet conveyance device according to claim 8, wherein the first roller is a rubber roller.

10. The sheet conveyance device according to claim 9, wherein the second roller is a plastic roller.

11. The sheet conveyance device according to claim 5, wherein a pitch of the recesses in the axial direction is 0.5 mm or larger and 5 mm or smaller.

12. The sheet conveyance device according to claim 7, wherein a pitch of the recesses in the axial direction is 0.5 mm or larger and 5 mm or smaller.

13. The sheet conveyance device according to claim 11, wherein a width of each projection in the axial direction is 0.2 mm or larger and 4 mm or smaller.

14. The sheet conveyance device according to claim 1, further comprising:
a rotational drive source configured to output rotational drive; and
a gear train configured to transmit the rotational drive output from the rotational drive source,
wherein the registration roller pair comprises a first rotation shaft and a second rotation shaft, the first rotation shaft being configured to be rotated by the rotational drive transmitted by the gear train, the second rotation shaft being disposed parallel to the first rotation shaft so as to be rotatable,
wherein the first roller is fixed to the first rotation shaft to be relatively unrotatable with respect to the first rotation shaft, and
wherein the second roller is fixed to the second rotation shaft to be relatively unrotatable with respect to the second rotation shaft.

15. The sheet conveyance device according to claim 1, further comprising a conveyance roller pair disposed upstream of the registration roller pair in a sheet conveyance direction and configured to cause the sheet to abut the registration roller pair and form a loop by conveying the sheet.

16. The sheet conveyance device according to claim 1, wherein the first roller comprises a portion which does not comprise the groove portion and nips a sheet with a portion of the second roller that does not comprise a groove portion.

17. An image forming apparatus comprising:
the sheet conveyance device according to claim 1; and
an image forming portion configured to form an image on a sheet whose skew has been corrected by the sheet conveyance device.

18. A sheet conveyance device comprising:
a registration roller pair comprising a first roller and a second roller, configured to form a nip by the first roller and the second roller, and configured to correct a skew of a sheet conveyed thereto by allowing the sheet to abut the nip,
wherein the first roller comprises plural grooves arranged in an axial direction.
